(19) United States
(12) Patent Application Publication
(10) Pub. No.: US 2006/0041738 A1
(43) Pub. Date: Feb. 23, 2006

(54) Recovery method for master boot record of hard disk drive

(76) Inventor: Yu-Chen Lai, Chung-Ho City (TW)

Correspondence Address: INTELLECTUAL PROPERTY / TECHNOLOGY LAW, PO BOX 14329, RESEARCH TRIANGLE PARK, NC, 27709, US

(21) Appl. No.: 10/920,074

(22) Filed: Aug. 17, 2004

(51) Int. Cl. G06F 9/24

(52) U.S. Cl. 713/2

(57) ABSTRACT

A recovery method for a master boot record of a hard disk drive is adapted to a computer system incorporating extensible firmware interface (EFI). When modification occurs in the master boot record, the extensible firmware interface stores the master boot record in an NVRAM (Non-volatile Random Access Memory) as a backup. The backup is read out for recovery of the hard disk driver if the master boot record is destroyed. The NVRAM is write-protected during runtime and the backup data stored therein is therefore free from destruction.

### FIELD OF THE INVENTION

The present invention relates to a recovery method for a master boot record of a hard disk drive and, more particularly, to a recovery method for a master boot record of a hard disk drive under the extensible firmware interface environment.

### BACKGROUND TO THE INVENTION

A personal computer is usually equipped with a hard disk drive for storing operating systems, other application programs and data files, etc. A hard disk drive may be divided into several logical partitions having different sizes; when a user starts using a hard disk drive for the first time, he/she will make a partition setting on the hard disk drive first, and each partition works as an independent drive. These setting values will be written into the master boot record (MBR). As shown in FIG. 1, a hard disk drive 100 has a master boot record 110 located on track 0 of the hard disk drive, and the master boot record 110 further comprises a bootstrap loader 112 and a partition table 114. The bootstrap loader 112 is used for loading an operating system into a main memory, and the partition table 114 is used for recording the data of the above-mentioned hard disk partitions. In this embodiment, the hard disk drive 100 is divided into two partitions, C: 122 and D: 124.

A personal computer further contains a low-level firmware generally known as Basic Input/Output System (BIOS) stored in a read-only memory (ROM). After a computer powers on, the basic input/output system runs first for proceeding initial values setting and power-on self test (POST). Next, the master boot record of the hard disk drive is read out, the bootstrap loader runs, and the location where an operating system is stored is found out by referring to the partition table to load the operating system into a main memory; thus the booting process is completed.

When a computer is infected with a boot sector virus, the master boot record and especially the data stored in the partition table will be destroyed by the virus. Sometimes, the master boot record is also probably destroyed by mis-operation of users. Thus, the data stored in the hard disk drive can not be used, resulting in failure to boot normally.

In order to recover the master boot record of a hard disk drive after being destroyed, conventionally, a backup of the master boot record is stored in advance usually in an unused sector of a hard disk drive such as, for example, the unused sector 132 or 134 (arrow X) of the hard disk drive 100 in FIG. 1.

Once the master boot record is detected to be destroyed due to infection of viruses, the backup data are read out and written back into track 0 (arrow Y). However, the unused sector of a hard disk drive has no protection, and the backup of master boot record stored in the unused sector of a hard disk drive may still be destroyed by viruses or other factors in case the hard disk drive is not locked up; on this occasion, the backup can not be read out for recovery.

On the other hand, because the development on the legacy BIOS has reached the limit, Intel Corporation has developed an extensible firmware interface (EFI) specification which can avoid the congenital limit of basic input/output system. Such an extensible firmware interface allows of using standard program language tools to add new components therein, which has better extensibility, and is programmed by C language so that the programs are easy to maintain and read. At present, the extensible firmware interface can support old systems to run on the present basic input/output system, and appropriately take over some controls. It is believed that such an extensible firmware interface will probably replace the basic input/output system completely in the future.

### SUMMARY OF THE INVENTION

The object of the present invention is to provide a recovery method for a master boot record of a hard disk drive, capable of backuping the master boot record effectively and avoiding the backup of master boot record from the possible destruction by computer viruses or users.

The recovery method for a master boot record of a hard disk drive of the present invention is adapted to, for example, a computer system incorporating an extensible firmware interface which stores the master boot record in an MBR variable of a non-volatile random access memory (NVRAM) when a modification occurs in the master boot record such as, for example, users change the hard disk partition settings. When the master boot record is destroyed, one can search the MBR variable in the non-volatile random access memory, read out the master boot record from the MBR variable as searched, and over-write the master boot record as read into the sector for master boot record of the hard disk drive.

Because the data stored in the non-volatile random access memory will not be lost on power-off, and can be only read therefrom but not written thereinto on runtime, the present invention storing the backup of master boot record in the non-volatile random access memory can avoid the backup data from destroyed and effectively overcome the drawback of the prior art storing the backup of master boot record in the hard disk drive.

### BRIEF DESCRIPTION OF THE DRAWINGS

One of the preferable embodiments of the present invention will now be described by way of examples with reference to the accompanying drawings in which:

FIG. 1 is a schematic illustration of actions of a recovery method for master boot record of the prior art.

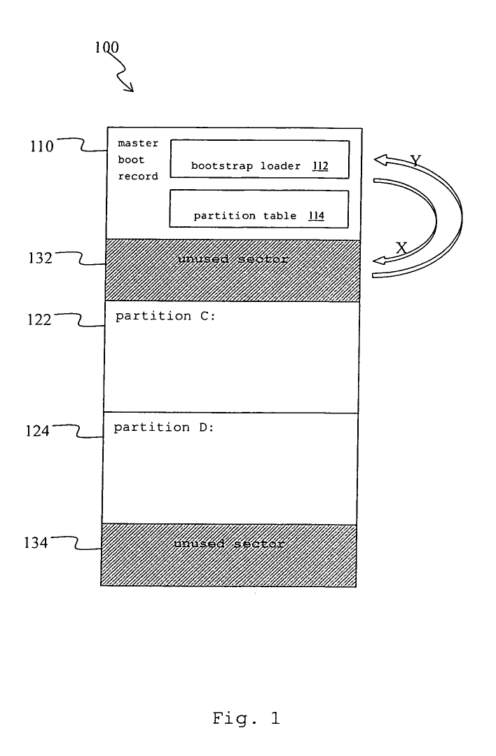

FIG. 2 is a schematic illustration of actions of the recovery method for master boot record of the present invention.

FIG. 3 is a flowchart of the recovery method for master boot record of the present invention.

### DESCRIPTION OF PREFERRED EMBODIMENTS

The recovery method and system for a master boot record of the present invention are suitably adapted to a computer system incorporating an extensible firmware interface, and thus this embodiment is merely illustrated under the extensible firmware interface environment. However, the technique of the present invention can be also adapted to a transition system in which the extensible firmware interface and the basic input/output system coexist.

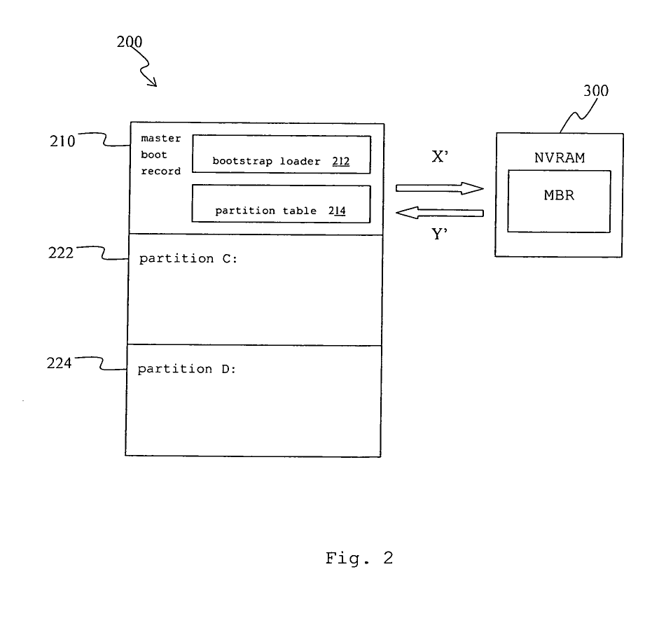

Referring to FIG. 2, the hard disk drive 200 which is similar to the architecture of a conventional hard disk drive has a master boot record (MBR) 210 located on track 0 of the hard disk drive. The master boot record 210 is created upon users divide the hard disk drive 200 for the first time, and further comprises an operating system loader (OS Loader) 212 and a partition table 214. The operating system loader 212 is used for loading an operation system into a main memory of a computer, and the partition table 214 is used for recording the data of the hard disk partitions. In this embodiment, the hard disk drive 200 is divided into two partitions C: 222 and D: 224. Whenever the user resets the hard disk partitions, the partition table 214 will be modified.

According to the present invention, after the master boot record 210 of the hard disk drive 200 is initially created, whenever a modification occurs, the master boot record 210 will be stored into a non-volatile random access memory 300 as a backup (arrow X′). Thus, when the system detects that the master boot record 210 is destroyed by infection with a boot sector virus or mis-operation of users, it can read out the backup of master boot record from the non-volatile random access memory 300 and over-write the backup into track 0 of the hard disk drive 200, so as to recover the master boot record of the hard disk drive (arrow Y′).

The non-volatile random access memory 300 is a readable/writable storage device in which the data stored will not be lost upon power-off, and said storage device is under a the write-protected condition upon runtime, which can only be read therefrom but not written thereinto. Therefore, computer viruses can not alter the contents of the non-volatile random access memory 300 so that the backup data are avoided from infection with viruses. In practical applications, the non-volatile random access memory 300 belongs to a part of the extensible firmware interface specification, which is used to store the EFI startup data and system data, etc. The data stored in the non-volatile random access memory 300 should be accessed through variable service; this interface stores or reads a configuration data sector by specifying a variable Name and a GUID (Globally Unique Identifier). In brief, the data in the non-volatile random access memory 300 are stored in the manner of variables, and each variable has a single Name and GUID. Therefore, it is possible to recognize whether the variable stored in the master boot record exists or not through Name and GUID.

The action of storing the master boot record 210 to the non-volatile random access memory 300 is achieved by a backup module which is automatically executed under a driver of the extensible firmware interface whenever the data of the hard disk partitions are modified. Also, the action of reading out the backup of master boot record from the non-volatile random access memory 300 and over-writing the backup into the hard disk drive 200 is achieved by a recovery module which is also existed under a driver or an application of the extensible firmware interface and automatically executed when detecting the master boot record is destroyed.

The reason for naming the extensible firmware interface by “Extensible” is it has a mechanism for extending functions by adding driver modules and application modules thereinto. If needed, these driver modules and application modules can be developed by programmers themselves according to the EFI specification established by Intel Corporation, so as to execute special operations. The above-mentioned backup modules and recovery modules are produced in this way.

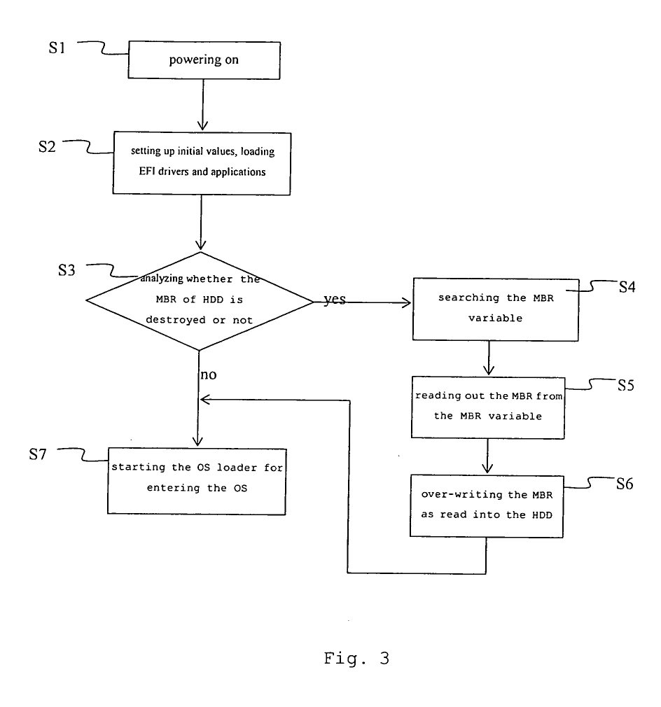

Referring to FIG. 3, there is shown a detail procedure of the recovery method for a master boot record of the present invention. When a computer incorporating an extensible firmware interface is powered on (step S1), an EFI boot manager will be executed first to set up system initial values, and then EFI drivers and applications are successively loaded (step S2). Next, whether the master boot record of hard disk drive is destroyed or not is analyzed (step S3). More specifically, in this step, if the extensible firmware interface read out the master boot record which has been altered by viruses, it will fail to find out the correct partitions of the hard disk drive according to this master boot record, whereby whether the master boot record is destroyed or not can be judged. If the master boot record is normal, the operating system loader is started for entering the operating system to complete the booting procedure (step S7). If it is detected in step S3 that the master boot record has been destroyed, the operating system can not be entered because the data in the hard disk drive can not be used. At this time, the recovery modules will execute steps S4˜S6 to search the MBR variable in the non-volatile random access memory, read out the previous backup of master boot record from the MBR variable as searched, and then over-write the backup data as read into track 0 of the hard disk drive (namely, the sector for storing the master boot record in the hard disk drive), so as to recover the master boot record. Because these actions are taken before loading the operating system, the operating system can be entered readily after the recovery is completed (step S7).

The non-volatile random access memory for storing the backup of master boot record in the present invention can be also replaced with an electrically erasable programmable read-only memory (EEPROM).

While the present invention has been shown and described with reference to a preferred embodiment thereof, and in terms of the illustrative drawings, it should not be considered as limited thereby. Various possible modifications, omissions, and alterations could be conceived of by one skilled in the art to the form and the content of any particular embodiment, without departing from the scope of the present invention.

What is claimed is:

1. A recovery method for a master boot record (MBR) of a hard disk drive adapted to a computer system incorporating an extensible firmware interface (EFI) which stores the master boot record in an MBR variable of a non-volatile random access memory (NVRAM) when a modification occurs in the master boot record, said recovery method including the following steps:
searching the MBR variable in said non-volatile random access memory;
reading out the master boot record from said MBR variable as searched; and
over-writing the master boot record as read into the sector for master boot record of said hard disk drive.

2. The recovery method as claimed in claim 1, wherein the master boot record comprises a partition table.

3. The recovery method as claimed in claim 1, wherein said non-volatile random access memory can be an electrically erasable programmable read-only memory (EEPROM).

4. A recovery system for a master boot record of a hard disk drive adapted to a computer system incorporating an extensible firmware interface, said recovery system including:
a backup module for storing a master boot record into a non-volatile random access memory when a modification occurs in the master boot record; and
a recovery module for reading out the master boot record from said non-volatile random access memory and over-writing the master boot record into the sector for master boot record of said hard disk drive.

5. The recovery system as claimed in claim 4, wherein the master boot record comprises a partition table.

6. The recovery system as claimed in claim 4, wherein said non-volatile random access memory can be an electrically erasable programmable read-only memory (EEPROM).

7. The recovery system as claimed in claim 4, wherein said backup module stores the master boot record in an MBR variable of said non-volatile random access memory.

8. The recovery system as claimed in claim 7, wherein said recovery module searches the MBR variable in said non-volatile random access memory, reads out the master boot record from the MBR variable as searched, and over-writes the master boot record as read into the sector for master boot record of said hard disk drive.

9. A computer-readable recording medium adapted to a computer system incorporating an extensible firmware interface which stores the master boot record in an MBR variable of a non-volatile random access memory when a modification occurs in the master boot record of a hard disk drive, said computer-readable recording medium enabling the computer to execute the following steps:
searching the MBR variable in said non-volatile random access memory;
reading out the master boot record from said MBR variable as searched; and
over-writing the master boot record as read into the sector for master boot record of said hard disk drive.

10. The computer-readable recording medium as claimed in claim 9, wherein the master boot record comprises a partition table.

11. The computer-readable recording medium as claimed in claim 9, wherein said non-volatile random access memory can be an electrically erasable programmable read-only memory (EEPROM).
